(19) United States
(12) Patent Application Publication
(10) Pub. No.: US 2016/0111127 A1
(43) Pub. Date: Apr. 21, 2016

(54) Generating a Composite Video of an Event Having a Moving Point of Attraction

(71) Applicant: INTERNATIONAL BUSINESS MACHINES CORPORATION, ARMONK, NY (US)

(72) Inventors: James E. Bostick, Cedar Park, TX (US); John M. Ganci, JR., Cary, NC (US); Sarbajit K. Rakshit, Kolkata (IN); Craig M. Trim, Sylmar, CA (US)

(21) Appl. No.: 14/515,573

(22) Filed: Oct. 16, 2014

(51) Int. Cl. G11B 27/02; G11B 27/34; G06T 7/20; G06K 9/00; H04N 5/247; H04N 5/265

(52) U.S. Cl. CPC G11B 27/02; H04N 5/247; H04N 5/265; G06T 7/2093; G06K 9/00718; G11B 27/34; G06T 2207/30241; G06T 2207/20221

(57) ABSTRACT

A composite video of a dynamic event having a moving point of attraction is created from images taken by cameras from multiple camera clusters. A determination is made as to which of the camera clusters has the highest level of image-capturing activity. The cluster with the highest level of image-capturing activity is deemed to be closest to the moving point of attraction at any particular point in time. As the moving point of attraction moves closer to other camera clusters, the level of image-capturing activity by cameras within those other camera clusters spikes, thus creating a roadmap of where the moving point of attraction is located and where the best images are captured. Images from the various camera clusters are then joined together to create a composite video of the dynamic event and the moving point of attraction.

### BACKGROUND

The present disclosure relates to the field of photography, and particular to the field of composite video files. Still more particularly, the present invention is related to generating a composite video file from multiple sources.

A dynamic event may include a moving point of attraction (MPOA). For example, a MPOA may be a racer (automotive, human, or animal), a celebrity (e.g., an actor, a politician, etc.), or any other moving object, animate or inanimate. If a spectator takes a photograph of such an MPOA with his/her camera, the captured image may be of poor quality, due to a poor field of view, a low quality camera being used, etc. A “video image” taken by such a camera may be a still photograph, a moving video file, and/or a composite thereof with or without sound.

### SUMMARY

In one embodiment of the present invention, a system comprises: multiple clusters of one or more cameras, wherein the multiple clusters are defined according to a physical location of each of the one or more cameras, and wherein each of the multiple clusters occupies a unique physical area; and a server for: identifying which cameras, within each of the multiple clusters, are capturing video images during a predefined first period of time; identifying which of the multiple clusters has a greatest quantity of cameras that are capturing video images during the predefined first period of time as compared to other clusters from the multiple clusters; determining a spatial relationship between a position of each of the multiple clusters and a moving point of attraction of the dynamic event during the predefined first period of time according to a quantity of cameras that are capturing video images during the predefined first period of time, wherein a first cluster having the greatest quantity of cameras that are capturing video images during the predefined first period of time is deemed to be closer to the moving point of attraction than other clusters from the multiple clusters during the predefined first period of time; identifying which cameras, within each of the multiple clusters, are capturing video images during a predefined second period of time; identifying which of the multiple clusters has a greatest quantity of cameras that are capturing video images during the predefined second period of time; determining a spatial relationship between a position of each of the multiple clusters and a moving point of attraction of the dynamic event during the predefined second period of time according to a quantity of cameras that are capturing video images during the predefined second period, wherein a second cluster having the greatest quantity of cameras that are capturing video images during the predefined second period of time is deemed to be closer to the moving point of attraction than other clusters from the multiple clusters during the predefined second period of time; and joining captured images from the first cluster during the predefined first period of time to captured images from the second cluster during the predefined second period of time to generate a composite video of the dynamic event having the moving point of attraction.

In one embodiment of the present invention, a method and/or computer program product generate a composite video of a dynamic event having a moving point of attraction, wherein the moving point of attraction is a component of the dynamic event. The method comprises: identifying a physical location of each of one or more cameras; generating multiple clusters of the one or more cameras according to the physical location of each of the one or more cameras, wherein each of the multiple clusters occupies a unique physical area; identifying which cameras, within each of the multiple clusters, are capturing video images during a predefined first period of time; identifying which of the multiple clusters has a greatest quantity of cameras that are capturing video images during the predefined first period of time as compared to other clusters from the multiple clusters; determining a spatial relationship between a position of each of the multiple clusters and a moving point of attraction of the dynamic event during the predefined first period of time according to a quantity of cameras that are capturing video images during the predefined first period, wherein a first cluster having the greatest quantity of cameras that are capturing video images during the predefined first period of time is deemed to be closer to the moving point of attraction than other clusters from the multiple clusters during the predefined first period of time; identifying which cameras, within each of the multiple clusters, are capturing video images during a predefined second period of time; identifying which of the multiple clusters has a greatest quantity of cameras that are capturing video images during the predefined second period of time; determining a spatial relationship between a position of each of the multiple clusters and a moving point of attraction of the dynamic event during the predefined second period of time according to a quantity of cameras that are capturing video images during the predefined second period, wherein a second cluster having the greatest quantity of cameras that are capturing video images during the predefined second period of time is deemed to be closer to the moving point of attraction than other clusters from the multiple clusters during the predefined second period of time; and joining captured images from the first cluster during the predefined first period of time to captured images from the second cluster during the predefined second period of time to generate a composite video of the dynamic event having the moving point of attraction.

### BRIEF DESCRIPTION OF THE SEVERAL VIEWS OF THE DRAWINGS

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 illustrates an exemplary racetrack environment in which the present invention generates a composite video file of a racecar, which is a moving object of attraction;

FIG. 5 depicts an exemplary sports stadium environment in which the present invention generates a composite video file from multiple discontinuous loci of increased camera activity; and

FIG. 6 is a high level flow-chart of one or more operations performed by one or more processors or other hardware devices to generate a composite video of a dynamic event having a moving point of attraction.

### DETAILED DESCRIPTION

In one or more embodiments, the present invention may be implemented as a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

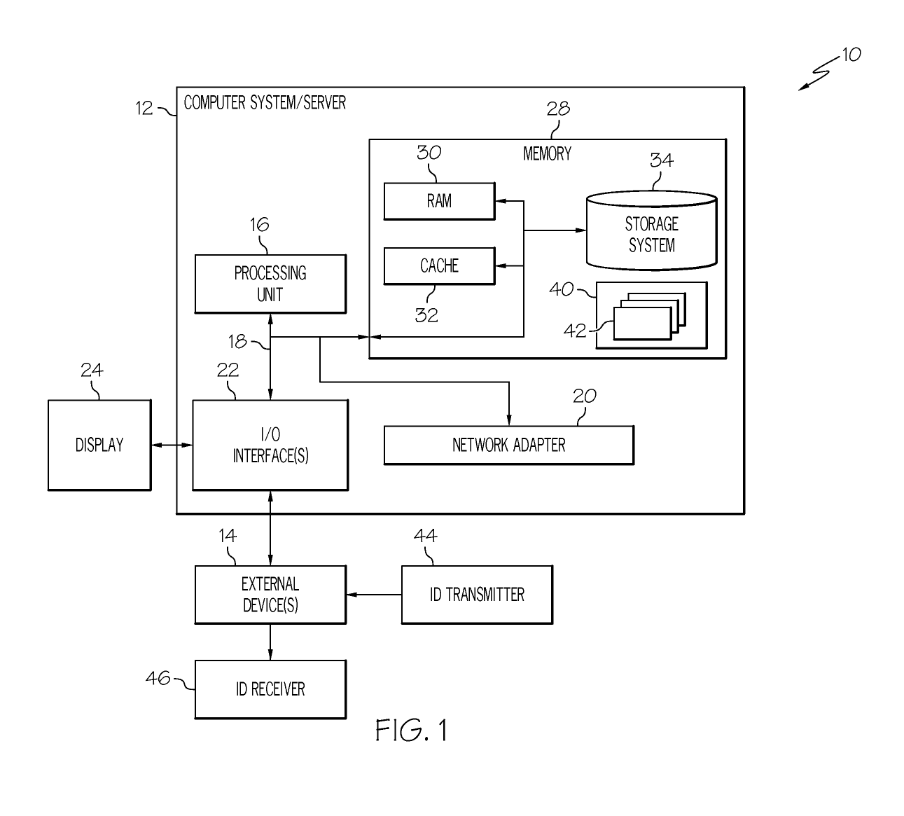

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

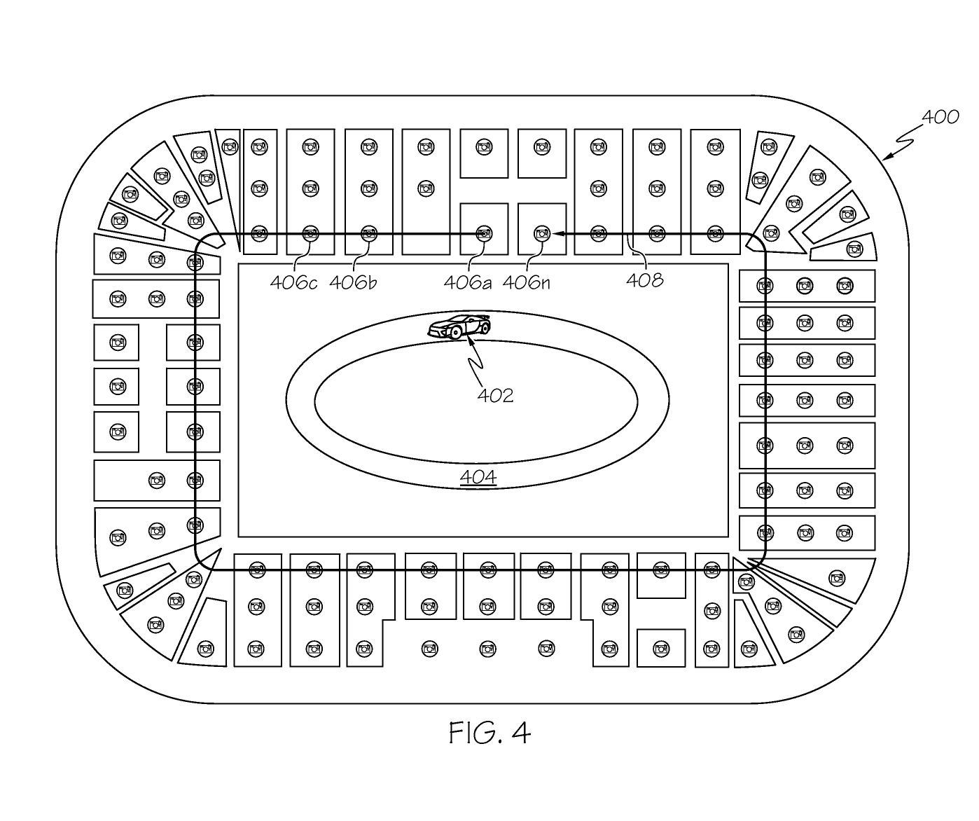

Note that external devices 14 that can utilize the computer system/server 12 shown in FIG. 1 include, but are not limited to, the cameras 406a-406n depicted in FIG. 4 below.

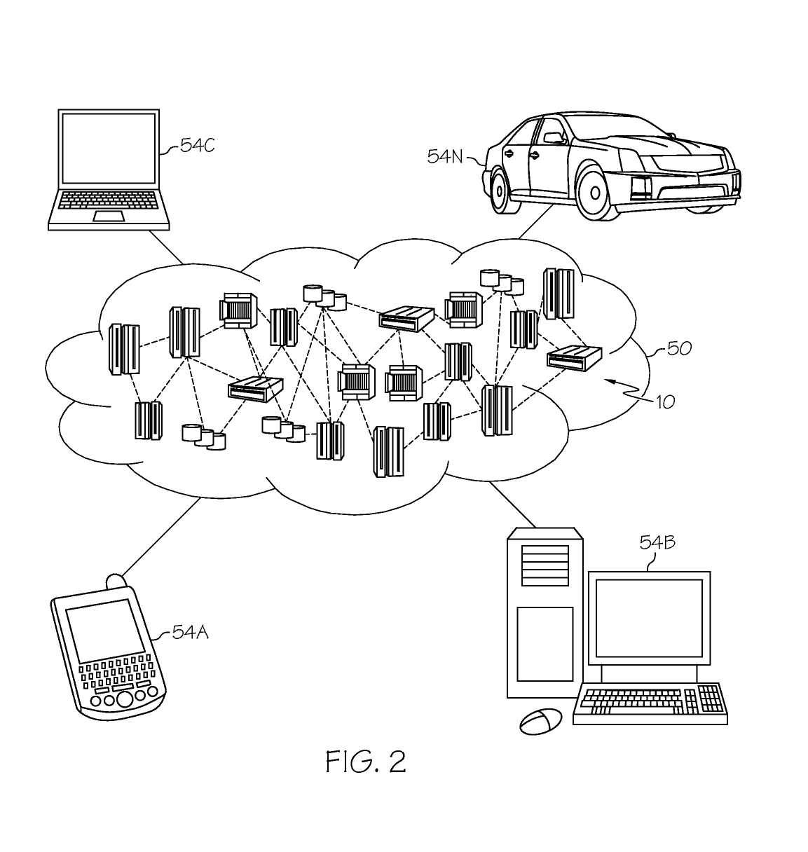

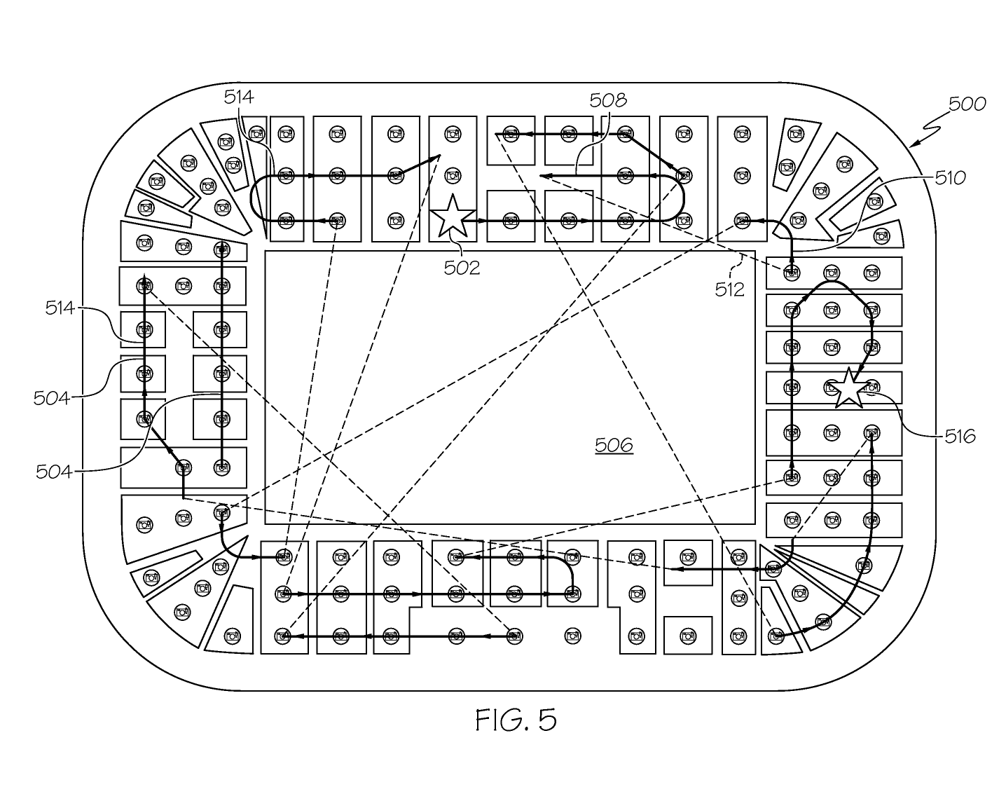

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices MA-N shown in FIG. 5 are intended to be illustrative only and that computing nodes 10 and cloud computing environment 50 can communicate with any type of computerized device over any type of network and/or network addressable connection (e.g., using a web browser).

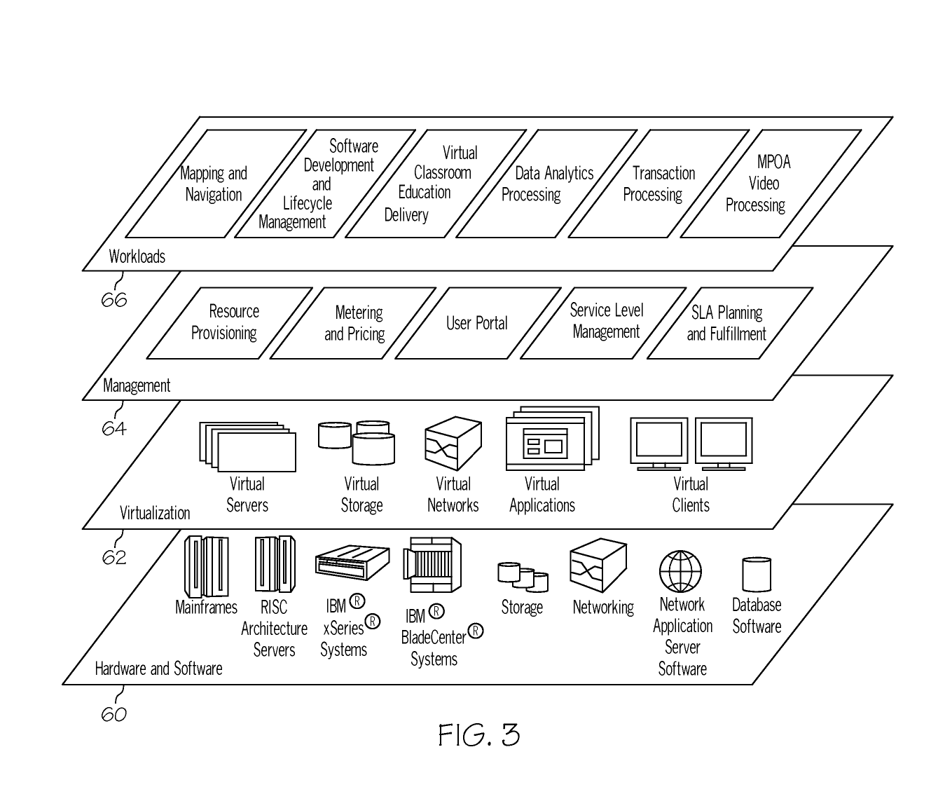

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide.)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and generating a composite video file of a Moving Point Of Attraction (MPOA), as described herein, and as represented by the “MPOA Video Processing” found in workloads layer 66.

With reference now to FIG. 4, an exemplary racetrack environment 400 in which the present invention generates a composite video file of a racecar, which is a moving point of attraction, is presented. For purposes of illustration, assume that a racecar 402 is traveling around a racetrack 404. Assume further that there are multiple clusters of cameras being used by spectators. That is, consider cluster 406a. Cluster 406a is a cluster of cameras (not individually depicted) being used by persons watching the racecar 402 as it travels past them. When the racecar is directly in front of spectators using the cameras that make up cluster 406a, a spike in camera usage occurs in cluster 406a as compared with other clusters 406b-406n (where “n” is an integer). As the racecar 402 progresses around the racetrack 404, it will later be in front of cluster 406b. At this time, the level of camera activity (i.e., persons taking pictures) in cluster 406a decreases, since racecar 402 has moved too far away to get a good picture. However, since racecar 402 is now close to cluster 406b, the picture-taking activity in cluster 406b will spike. Thus, there is a “wave” of picture-taking activity that moves from cluster to cluster as the racecar 402 moves around the racetrack 404, as depicted by line 408. That is, as the racecar 402 moves around the racetrack 404, picture-taking activity will initially spike in cluster 406a. As the racecar 402 continues to move around the racetrack 404, the picture-taking activity will decrease in cluster 406a and will spike in cluster 406b. As the racecar 402 continues to move around the racetrack 404, the picture-taking activity will decrease in cluster 406b and will spike in cluster 406c, and so on until there is a spike in picture-taking activity in cluster 406n. Thereafter, there is a decrease in picture-taking activity in cluster 406n, and a new spike in picture-taking activity in cluster 406a.

This undulating pattern of picture-taking activity will 1) identify where the racecar 402 is located, and 2) identify which clusters from clusters 406a-406n have the best vantage points for photographing the racecar 402. In one embodiment of the present invention, the photographic images/streams from the various clusters 406a-406n are then stitched together to create a composite video file, which shows a continuous video of the racecar 402 as it traverses around the racetrack 404.

As just described, FIG. 4 illustrates an example in which a Moving Point Of Attraction (MPOA), such as the racecar 402, moves in continuous route. However, in other environments, the MPOA moves in a disjunctive manner. For example, consider sports stadium 500 in FIG. 5, which presents an exemplary sports stadium environment in which the present invention generates a composite video file from multiple discontinuous loci of increased camera activity. As depicted in FIG. 5, assume that the sports stadium 500 is a football (American soccer) stadium. Assume that the action of interest begins near the cluster depicted as start point 502. As depicted by arrows 504, various clusters increase the level of camera activity based on how the action moves on the field 506. For example, assume that this moving action (i.e., MPOA) is the soccer ball. As the soccer ball moves around on the field 506, camera activity spikes move accordingly from cluster to cluster in a contiguous manner, such that increases in camera activity move from one cluster to an adjacent/contiguous cluster. However, at some point, the soccer ball may be kicked across the field, resulting in camera activity spikes moving from the cluster at the head of line 508 to the cluster at the tail of line 510. This jump is identified and depicted by the connector line 512. Other discontinuous loci of camera action 514 are similarly connected by other connector lines until the action reaches the end point of locus 516.

As in FIG. 4, in one embodiment of the present invention, the camera images (either still images or moving video images) from the clusters having activity spikes are stitched together, either in real time or afterwards, to create a continuous video of uninterrupted action on the field 506.

Thus, as depicted in FIG. 1, FIG. 4 and FIG. 5, one embodiment of the present invention is a hardware-based system for joining captured images from different clusters of cameras. As depicted in FIG. 4, there are multiple clusters (e.g., clusters 406a-406n), each of which includes one or more cameras. These multiple clusters are defined according to a physical location of each of the one or more cameras. That is, a cluster is defined according to the location (i.e., a unique physical area) that is occupied by a set of one or more cameras, which may be still cameras or video cameras. Such cameras may be devices that are primarily cameras, or they may be components of a device the is primarily a computing and/or communication device, such as a smart phone. In one embodiment, the cameras have telecommunication abilities, such that they are able to upload their captured video images to a server, such as computer system/server 12 depicted in FIG. 1. That is, in one embodiment the clusters are external device(s) 14 depicted in FIG. 1, and the server is computer system/server 12 depicted in FIG. 1. However, if the system is not cloud-based, then the server is any server that is able to communicate, either wirelessly in real-time, or by physically downloading images from memory cards, etc., from/with the cameras in the clusters.

In one or more embodiments of the present invention, the server has the ability to define clusters, identify camera spikes in the clusters, receive (either in real time or later from memory cards, etc.) video images from cameras, stitch the video images into a continuous file, etc.

Thus, in one or more embodiments, the server identifies which cameras, within each of the multiple clusters, are capturing video images during a predefined first period of time. The server then identifies which of the multiple clusters has a greatest quantity of cameras that are capturing video images during the predefined first period of time as compared to other clusters from the multiple clusters. For example, initially cluster 406a in FIG. 4 may have a higher number of cameras taking pictures at a particular point in time than any of the other clusters 406b-406n. In one embodiment, this camera identification is achieved by a real-time wireless communication session between each of the cameras and the server. This communication session includes the transmittal of 1) an indicator that the camera is capturing images, and/or 2) a copy of the captured images themselves.

Note that in one embodiment, it is the quantity of cameras taking photos that identifies a most active cluster. That is, a cluster that has 5 cameras taking photos within a certain period of time (e.g., within a certain 10 seconds) is deemed to be closer to the “action” than another cluster in which only 2 cameras are taking photos during that same 10 seconds. However, in another embodiment, it is the raw number of captured images alone that matter. That is, even if only one camera is taking photos within a certain cluster, if that camera takes 20 photos within the 10-second window, this cluster is deemed to be closer to the MPOA than another cluster having 10 cameras that are only taking 1 photo apiece during that 10-second window.

The server also determines a spatial relationship between a position of each of the multiple clusters and a moving point of attraction of a dynamic event during the predefined first period of time according to a quantity of cameras (or captured images) that are capturing video images during the predefined first period of time, wherein a first cluster having the greatest quantity of cameras that are capturing video images during the predefined first period of time is deemed to be closer to the moving point of attraction than other clusters from the multiple clusters during the predefined first period of time. For example, assume that the predefined first period of time is time T1. At T1, camera activity spikes for cameras in cluster 406a. Thus, the server determines that the racecar 402 is closer to cluster 406a than to any of the other clusters 406b-406n.

The server is also able to identify which cameras, within each of the multiple clusters, are capturing video images during a predefined second period of time, as described above for the predefined first period of time. Thus, the server is able to identify which of the multiple clusters has a greatest quantity of cameras that are capturing video images during the predefined second period of time. In one scenario, the cluster with the greatest quantity of cameras capturing video images remains the same. However, in another scenario, the cluster with the greatest quantity of cameras capturing video images switches from one cluster to another cluster.

Thus, the server determines a spatial relationship between a position of each of the multiple clusters and a moving point of attraction of the dynamic event during the predefined second period of time according to a quantity of cameras that are capturing video images during the predefined second period of time. That is, a second cluster having the greatest quantity of cameras that are capturing video images during the predefined second period of time is deemed to be closer to the moving point of attraction than other clusters from the multiple clusters during the predefined second period of time. This describes the scenario shown in FIG. 4, in which the cluster spikes move along line 408.

The server then joins captured images from the first cluster during the predefined first period of time to captured images from the second cluster during the predefined second period of time to generate a composite video of the dynamic event having the moving point of attraction. For example, assume that cluster 406a in FIG. 4 had the initial highest number of cameras in action during a first period of time, while cluster 406b had the highest number of cameras in action during a second period of time. The images from cluster 406a during the first period of time are stitched together with the images from cluster 406b during the second period of time to create the composite video image of the movement of the racecar 402.

In one embodiment, the server also ranks each of the captured images. This ranking can be according to various criteria. For example, in one embodiment the captured images are ranked by the server according to pixel density of the captured image. For example, one image may have a pixel density (i.e., “resolution”) of 256×256 pixels. This is a rather low resolution level. Another camera may have a resolution of 1600×1200 pixels, which is a high resolution image. The ranking, however, may be according to the lowest or the highest resolution levels. That is, in a first embodiment, image quality is paramount. However, in a second embodiment, speed may be paramount. Thus, in the first embodiment, more bandwidth will be required to upload the images, and thus the uploads will be slower. In the second embodiment, uploads will be faster (and thus the composite image will be closer to being in real-time), but the image quality will suffer.

In one embodiment, the server ranks the captured images according to image clarity. That is, pixel density is but one component of image clarity. A camera may produce a 1600×1200 pixel image, but if the photographer was shaking or the light level was too low, then the image clarity may be low (e.g., blurry, too dark, etc.) Thus, only the highest ranked images (i.e., the images with the best clarity, assuming that they do not consume too much bandwidth when being uploaded) will be used to create the composite video of the dynamic event having a moving point of attraction.

In one embodiment of the present invention, the server ranks the captured images by defining a particular moving object within the moving point of attraction, and then ranking the captured images according to whether or not a particular captured image includes an image of the particular moving object. For example, assume in FIG. 4 that the racecar 402 is the particular moving object within the moving point of attraction (which may be a head-to-head race between racecar 402 and another racecar). The server utilizes image processing (e.g., point, shape, and color mapping) to identify the image that is racecar 402. Thus, any captured image that includes an image of racecar 402 is ranked higher than a captured image that does not include racecar 402. In another embodiment, racecar 402 emits an electronic identification signal from a line-of-sight transmitter. That is, a transmitter (i.e., ID transmitter 44 shown in FIG. 1) on racecar 402 emits an electronic identification signal that is only received by a camera/device (e.g., one of the external device(s) 14 shown in FIG. 1) that is pointed at the racecar 402. If the camera/device receives this electronic signal while taking a photograph of the racecar 402 (e.g., using an ID receiver within the camera/device, such as ID receiver 46 shown in FIG. 1), then a metatag is attached to the captured image identifying the racecar 402. However, if this electronic signal is not received while taking a photograph of the racecar 402, then no metatag is attached to the captured image identifying the racecar 402, and the image is ranked lower.

In one embodiment of the present invention, the server ranks the captured images by ranking multiple models of cameras, and then ranking the captured images according to a ranking of cameras that took the captured images. For example, assume that one camera is a standard definition (SD) camera, while another camera is a high definition (HD) camera. If image quality is of the highest importance to how the composite video of the dynamic event is created, then the HD camera will be ranked higher than the SD camera. However, the image from the HD camera will consume more bandwidth in any communication between the camera(s) and the server. Thus, if speed is more important in how the composite video of the dynamic event is created, then the SD camera will be ranked higher.

In one embodiment of the present invention, the server further identifies a particular cluster that is capturing a greatest quantity of images of the moving point of attraction by 1) determining a total number of cameras from the one or more cameras that are capturing images during a specific period of time; 2) dividing a first quantity of cameras, from the particular cluster, that are capturing images during the specific period of time by all cameras from the one or more cameras that are capturing images during the specific period of time to generate a camera cluster ratio; 3) determining that the camera cluster ratio for the particular cluster exceeds a predetermined value; and 4) determining that the particular cluster is capturing the greatest quantity of images of the moving point of attraction. That is, rather than just taking a raw number of how many cameras in a particular cluster are taking photos at any given period of time (thus determining whether or not the MPOA is proximate to that particular cluster), in this embodiment it is the relative number of cameras within any particular cluster that matters. For example, if a particular cluster contains cameras that are shooting 20% of all photos being generated within a stadium during a certain period of time, and the next most active cluster has cameras that shoot only 10% of the photos taken during that time, then the raw number of cameras taking photographs is deemed less important than the percentage of total cameras within the stadium that are shooting photos. Thus, the cluster of cameras that are shooting 20% of the photos during any particular period of time is deemed to be closest to the MPOA.

In one embodiment of the present invention, the server identifies a particular object within the moving point of attraction; associates the particular object with the composite video; receives a request for a video of the particular object in motion from a requesting party; and returns the composite video to the requesting party. That is, after the composite video is created by stitching together photos/videos from the various clusters, a requester may ask for a composite video that has a video record of a particular object (e.g., the racecar 402 shown in FIG. 4). By identifying the racecar 402 as being within a certain composite video (using image recognition processes such as those described above), then the composite video that includes racecar 402 will be returned to the requester.

In one embodiment of the present invention, the server receives the captured video images in real time. For example, assume that (all or some of) the cameras within the clusters shown in FIG. 4 and FIG. 5 are able to wirelessly communicate with the server. In this embodiment, as soon as the images are captured by the cameras, they are immediately uploaded to the server, thus allowing the server to generate a near real-time composite video of the MPOA.

In one embodiment of the present invention, the server receives a time stamp for images received from the first cluster and the second cluster, wherein images from the first cluster are captured before images from the second cluster; and places images captured by the first cluster before images captured by the second cluster in the composite video. For example and with reference again to FIG. 4, assume that cameras within cluster 406a take pictures of racecar 402 at an initial first time (T1), and the cameras within cluster 406b take pictures of racecar 402 at a subsequent second time (T2). The timestamps for T1 and T2 will be attached to the photos respectively taken in cluster 406a and cluster 406b, thus indicating which photos were taken first and second, in order to create a smooth and sequential composite video of the MPOA that is racecar 402.

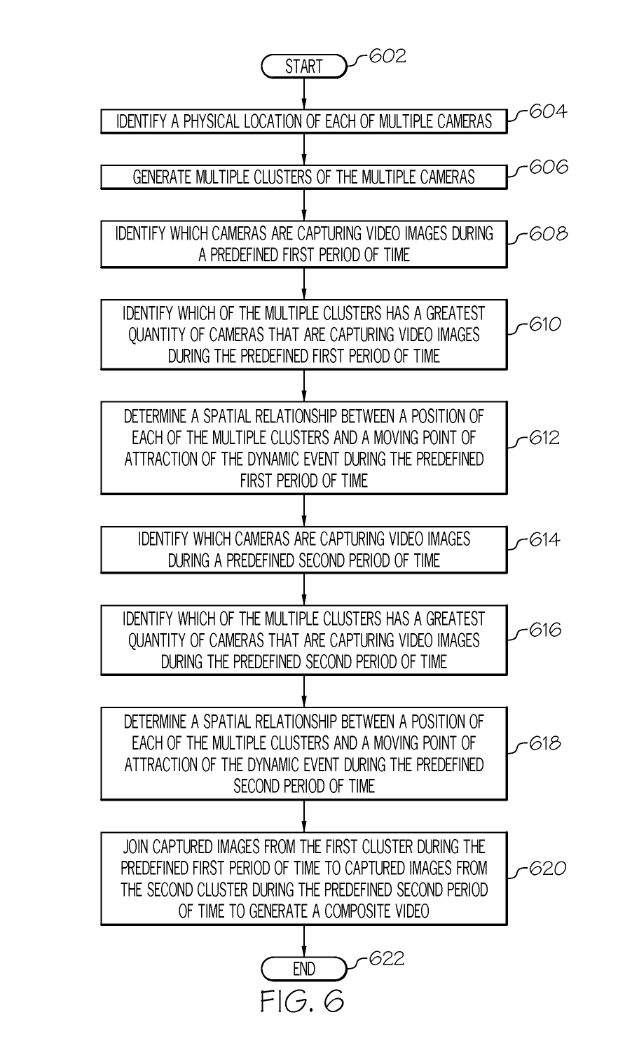

With reference now to FIG. 6, a high level flow-chart of one or more operations performed by one or more processors or other hardware devices to composite video of a dynamic event having a moving point of attraction is presented. Note that the moving point of attraction (MPOA) is a component of the dynamic event. For example, the dynamic event may be a race, and the MPOA may be a particular racer, which may be animate (e.g., a person, horse, etc.) or inanimate (e.g., a racecar).

After initiator block 602, a physical location of each of one or more cameras within a particular area (e.g., a stadium, a route of a motorcade, etc.) is identified (block 604). As described in block 606, using these camera locations, multiple clusters of the one or more cameras are generated according to the physical location of each of the one or more cameras, where each of the multiple clusters occupies a unique physical area. For example, the clusters 406a-406n in FIG. 4 are generated based on their physical location within the stadium 400.

As described in block 608, an identification is made of which cameras, within each of the multiple clusters, are capturing video images during a predefined first period of time. That is, cameras, within the generated clusters, that are taking pictures during the initial predefined first period of time are identified.

Based on the identification of which cameras are shooting photos/videos during the predetermined first period of time, an identification is made as to which of the multiple clusters has a greatest quantity of cameras that are capturing video images during the predefined first period of time as compared to other clusters from the multiple clusters (block 610). As described herein, this quantity may be a raw number, or it may be a percentage of all cameras within a certain physical location (e.g., within a stadium).

As described in block 612, a spatial relationship between a position of each of the multiple clusters and a moving point of attraction of the dynamic event during the predefined first period of time is determined according to a quantity of cameras that are capturing video images during the predefined first period, wherein a first cluster having the greatest quantity of cameras that are capturing video images during the predefined first period of time is deemed to be closer to the moving point of attraction (MPOA) than other clusters from the multiple clusters during the predefined first period of time. That is, whichever cluster has the most cameras shooting images during a certain period of time is deemed to be closest to the MPOA.

As described in blocks 614-618, the process described in blocks 608-612 is reiterated for a predefined second period of time. That is, block 614 describes identifying which cameras, within each of the multiple clusters, are capturing video images during a predefined second period of time; block 616 describes identifying which of the multiple clusters has a greatest quantity of cameras that are capturing video images during the predefined second period of time; and block 618 describes determining a spatial relationship between a position of each of the multiple clusters and a moving point of attraction of the dynamic event during the predefined second period of time according to a quantity of cameras that are capturing video images during the predefined second period, wherein a second cluster having the greatest quantity of cameras that are capturing video images during the predefined second period of time is deemed to be closer to the moving point of attraction than other clusters from the multiple clusters during the predefined second period of time.

As described in block 620, captured images from the first cluster during the predefined first period of time and captured images from the second cluster during the predefined second period of time are joined/combined/stitched together to generate a composite video of the dynamic event having the moving point of attraction. The flow-chart ends at terminator block 622.

In one embodiment of the present invention, a particular cluster that is capturing a greatest quantity of images of the moving point of attraction is identified by: determining a total number of cameras from the one or more cameras that are capturing images during a specific period of time; dividing a first quantity of cameras, from the particular cluster, that are capturing images during the specific period of time by all cameras from the one or more cameras that are capturing images during the specific period of time to generate a camera cluster ratio; determining that the camera cluster ratio for the particular cluster exceeds a predetermined value; and determining that the particular cluster is capturing the greatest quantity of images of the moving point of attraction. That is, as described above, in one embodiment of the present invention, the cluster that is deemed to be closest to the MPOA is not just the cluster that has the most cameras that are shooting photos/videos at any particular period of time, but rather is the cluster that has the highest percentage of cameras from within the entire predefined area (e.g., a stadium, a motorcade route, etc.) that are taking photos/videos during that particular period of time.

In one embodiment of the present invention, a particular object within the moving point of attraction is identified; the particular object is associated with the composite event; a request for a video of the particular object in motion is received from a requesting party; and the composite video is returned to the requesting party. That is, the system determines what MPOA is captured by the composite video. When the system receives a request for video of that MPOA, then the composite video that contains images of the MPOA is returned to the requester.

In one embodiment of the present invention, the system (e.g., the server) receives the captured video images in real time, as described above.

In one embodiment of the present invention, the system (e.g., the server) receives a time stamp for images received from a first cluster and a second cluster, wherein images from the first cluster are captured before images from the second cluster; and then places images captured by the first cluster before images captured by the second cluster in the composite video. That is, the timestamps allow the system to generate a composite video in which captured images are in chronological order.

As described herein and in one or more embodiments of the present invention, a method and/or system is presented for capturing, searching, and/or displaying ranked media content for events with moving points of attraction.

As described herein, multiple users capture media content for an event. Users are at different locations within a venue and may have different points of interest of the event based on their interests when capturing media content (i.e., a photo, video, etc.). The users then upload their captured media content to a remote server, which processes the captured media content according to the media content location and time. The remote server also aggregates and correlates the captured media content based on defined time periods, and creates a locus of camera photo clicks and/or video recordings for the duration of the event. Based on the analysis of the media content, one or more loci of camera action (i.e., photo click or video recording) are drawn. Media content may be ranked based on various parameters described herein. When a requester asks for a combined video, the request can be filtered according to criteria described herein. The combined video can then be displayed either by the server, or downloaded to the requester for display at the requester's device.

Thus, as described herein, the present invention gathers and performs analytics on media content for an event, whereby the content is aggregated and correlated for specific time periods and location, thereby determining optimal vantage points for viewing an attraction. This process enables the system to key in on specific personalities, celebrities, and/or other objects (animate or inanimate), whether such subjects are directly in or out of the area of focus and/or central field of view of some of the camera(s).

The invention provides a method of ranking the media content based on the locus of point of attraction camera action (i.e., photo click or video recording). The locus of click action is created by joining two adjacent click action concentrations. The point of attraction is dynamic, as it moves from point to point. In one embodiment, the end of one discontinuous locus is combined with a start point of another discontinuous locus to create a continuous locus of point of attraction.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A system comprising:
multiple clusters of one or more cameras, wherein the multiple clusters are defined according to a physical location of each of the one or more cameras, and wherein each of the multiple clusters occupies a unique physical area; and
a server for:
identifying which cameras, within each of the multiple clusters, are capturing video images during a predefined first period of time;
identifying which of the multiple clusters has a greatest quantity of cameras that are capturing video images during the predefined first period of time as compared to other clusters from the multiple clusters;
determining a spatial relationship between a position of each of the multiple clusters and a moving point of attraction of a dynamic event during the predefined first period of time according to a quantity of cameras that are capturing video images during the predefined first period of time, wherein a first cluster having the greatest quantity of cameras that are capturing video images during the predefined first period of time is deemed to be closer to the moving point of attraction than other clusters from the multiple clusters during the predefined first period of time;
identifying which cameras, within each of the multiple clusters, are capturing video images during a predefined second period of time;
identifying which of the multiple clusters has a greatest quantity of cameras that are capturing video images during the predefined second period of time;
determining a spatial relationship between a position of each of the multiple clusters and a moving point of attraction of the dynamic event during the predefined second period of time according to a quantity of cameras that are capturing video images during the predefined second period of time, wherein a second cluster having the greatest quantity of cameras that are capturing video images during the predefined second period of time is deemed to be closer to the moving point of attraction than other clusters from the multiple clusters during the predefined second period of time; and
joining captured images from the first cluster during the predefined first period of time to captured images from the second cluster during the predefined second period of time to generate a composite video of the dynamic event having the moving point of attraction.

2. The system of claim 1, wherein the server further:
ranks each of the captured images.

3. The system of claim 2, wherein the captured images are ranked according to pixel density of the captured images.

4. The system of claim 2, wherein the captured images are ranked according to image clarity of the captured images.

5. The system of claim 2, wherein the captured images are ranked by:
defining a particular moving object within the moving point of attraction; and
ranking the captured images according to whether or not a particular captured image includes an image of the particular moving object.

6. The system of claim 2, wherein the captured images are ranked by:
ranking multiple models of cameras; and
ranking the captured images according to a ranking of cameras that took the captured images.

7. The system of claim 1, wherein the server further:
identifies a particular cluster that is capturing a greatest quantity of images of the moving point of attraction by:
determining a total number of cameras from the one or more cameras that are capturing images during a specific period of time;
dividing a first quantity of cameras, from the particular cluster, that are capturing images during the specific period of time by all cameras from the one or more cameras that are capturing images during the specific period of time to generate a camera cluster ratio;
determining that the camera cluster ratio for the particular cluster exceeds a predetermined value; and
determining that the particular cluster is capturing the greatest quantity of images of the moving point of attraction.

8. The system of claim 1, wherein the server further:
identifies a particular object within the moving point of attraction;
associates the particular object with the composite video;
receives a request for a video of the particular object in motion from a requesting party; and
returns the composite video to the requesting party.

9. The system of claim 1, wherein the server further:
receives the captured images in real time.

10. The system of claim 1, wherein the server further:
receives a time stamp for images received from the first cluster and the second cluster, wherein images from the first cluster are captured before images from the second cluster; and
places images captured by the first cluster before images captured by the second cluster in the composite video.

11. A method to generate a composite video of a dynamic event having a moving point of attraction, wherein the moving point of attraction is a component of the dynamic event, and wherein the method comprises:
identifying a physical location of each of one or more cameras;
generating multiple clusters of the one or more cameras according to the physical location of each of the one or more cameras, wherein each of the multiple clusters occupies a unique physical area;
identifying which cameras, within each of the multiple clusters, are capturing video images during a predefined first period of time;
identifying which of the multiple clusters has a greatest quantity of cameras that are capturing video images during the predefined first period of time as compared to other clusters from the multiple clusters;
determining a spatial relationship between a position of each of the multiple clusters and a moving point of attraction of the dynamic event during the predefined first period of time according to a quantity of cameras that are capturing video images during the predefined first period of time, wherein a first cluster having the greatest quantity of cameras that are capturing video images during the predefined first period of time is deemed to be closer to the moving point of attraction than other clusters from the multiple clusters during the predefined first period of time;
identifying which cameras, within each of the multiple clusters, are capturing video images during a predefined second period of time;
identifying which of the multiple clusters has a greatest quantity of cameras that are capturing video images during the predefined second period of time;
determining a spatial relationship between a position of each of the multiple clusters and a moving point of attraction of the dynamic event during the predefined second period of time according to a quantity of cameras that are capturing video images during the predefined second period of time, wherein a second cluster having the greatest quantity of cameras that are capturing video images during the predefined second period of time is deemed to be closer to the moving point of attraction than other clusters from the multiple clusters during the predefined second period of time; and
joining captured images from the first cluster during the predefined first period of time to captured images from the second cluster during the predefined second period of time to generate a composite video of the dynamic event having the moving point of attraction.

12. The method of claim 11, further comprising:
identifying a particular cluster that is capturing a greatest quantity of images of the moving point of attraction by:
determining a total number of cameras from the one or more cameras that are capturing images during a specific period of time;
dividing a first quantity of cameras, from the particular cluster, that are capturing images during the specific period of time by all cameras from the one or more cameras that are capturing images during the specific period of time to generate a camera cluster ratio;
determining that the camera cluster ratio for the particular cluster exceeds a predetermined value; and
determining that the particular cluster is capturing the greatest quantity of images of the moving point of attraction.

13. The method of claim 11, further comprising:
identifying a particular object within the moving point of attraction;
associating the particular object with the composite video;
receiving a request for a video of the particular object in motion from a requesting party; and
returning the composite video to the requesting party.

14. The method of claim 11, further comprising:
receiving the captured images in real time.

15. The method of claim 11, further comprising:
receiving a time stamp for images received from the first cluster and the second cluster, wherein images from the first cluster are captured before images from the second cluster; and
placing images captured by the first cluster before images captured by the second cluster in the composite video.

16. A computer program product for generating a composite video of a dynamic event having a moving point of attraction, wherein the moving point of attraction is a component of the dynamic event, wherein the computer program product comprises a computer readable storage medium having program code embodied therewith, wherein the computer readable storage medium is not a transitory signal per se, and wherein the program code is readable and executable by a processor to perform a method comprising:
identifying a physical location of each of one or more cameras;
generating multiple clusters of the one or more cameras according to the physical location of each of the one or more cameras, wherein each of the multiple clusters occupies a unique physical area;
identifying which cameras, within each of the multiple clusters, are capturing video images during a predefined first period of time;
identifying which of the multiple clusters has a greatest quantity of cameras that are capturing video images during the predefined first period of time as compared to other clusters from the multiple clusters;
determining a spatial relationship between a position of each of the multiple clusters and a moving point of attraction of the dynamic event during the predefined first period of time according to a quantity of cameras that are capturing video images during the predefined first period of time, wherein a first cluster having the greatest quantity of cameras that are capturing video images during the predefined first period of time is deemed to be closer to the moving point of attraction than other clusters from the multiple clusters during the predefined first period of time;
identifying which cameras, within each of the multiple clusters, are capturing video images during a predefined second period of time;
identifying which of the multiple clusters has a greatest quantity of cameras that are capturing video images during the predefined second period of time;
determining a spatial relationship between a position of each of the multiple clusters and a moving point of attraction of the dynamic event during the predefined second period of time according to a quantity of cameras that are capturing video images during the predefined second period of time, wherein a second cluster having the greatest quantity of cameras that are capturing video images during the predefined second period of time is deemed to be closer to the moving point of attraction than other clusters from the multiple clusters during the predefined second period of time; and
joining captured images from the first cluster during the predefined first period of time to captured images from the second cluster during the predefined second period of time to generate a composite video of the dynamic event having the moving point of attraction.

17. The computer program product of claim 16, wherein the method further comprises:
identifying a particular cluster that is capturing a greatest quantity of images of the moving point of attraction by:
determining a total number of cameras from the one or more cameras that are capturing images during a specific period of time;
dividing a first quantity of cameras, from the particular cluster, that are capturing images during the specific period of time by all cameras from the one or more cameras that are capturing images during the specific period of time to generate a camera cluster ratio;
determining that the camera cluster ratio for the particular cluster exceeds a predetermined value; and
determining that the particular cluster is capturing the greatest quantity of images of the moving point of attraction.

18. The computer program product of claim 16, wherein the method further comprises:
identifying a particular object within the moving point of attraction;
associating the particular object with the composite video;
receiving a request for a video of the particular object in motion from a requesting party; and
returning the composite video to the requesting party.

19. The computer program product of claim 16, wherein the method further comprises:
receiving the captured images in real time.

20. The computer program product of claim 16, wherein the method further comprises:
receiving a time stamp for images received from the first cluster and the second cluster, wherein images from the first cluster are captured before images from the second cluster; and
placing images captured by the first cluster before images captured by the second cluster in the composite video.
